(19) United States
(12) Patent Application Publication
(10) Pub. No.: US 2022/0124708 A1
(43) Pub. Date: Apr. 21, 2022

(54) RADIO BASE STATION AND USER EQUIPMENT

(71) Applicant: NTT DOCOMO, INC., Tokyo (JP)

(72) Inventors: Tooru Uchino, Tokyo (JP); Tianyang Min, Tokyo (JP); Kenji Kai, Tokyo (JP); Teruaki Toeda, Tokyo (JP)

(73) Assignee: NTT DOCOMO, INC., Tokyo (JP)

(21) Appl. No.: 17/432,871

(22) PCT Filed: Feb. 22, 2019
(86) PCT No.: PCT/JP2019/006926

§ 371 Date: Aug. 20, 2021

(51) Int. Cl. H04W 72/04

(52) U.S. Cl. CPC H04W 72/0446

(57) ABSTRACT

A gNB (200) includes a receiving unit (203) that receives a plurality of TSN times (T1, T2, and T3); a control unit (205) that associates a time identifier (TSN1, TSN2, and TSN3) with each of the plurality of TSN times (T1, T2, and T3); and a transmitting unit (201) that transmits the plurality of TSN times (T1, T2, and T3) and the time identifier (TSN1, TSN2, and TSN3) associated with each of the plurality of TSN times (T1, T2, and T3) to a UE (100). Each TSN time (T1, T2, and T3) is a time reference in the TSN (20a, 20b, and 20c).

### TECHNICAL FIELD

The present invention relates to a radio base station and a user equipment used for remote control.

### BACKGROUND ART

The 3rd generation partnership project (3GPP) specifies Long Term Evolution (LTE), and specifies LTE-Advanced (hereinafter, collectively referred to as LTE) for the purpose of further speeding up LTE. In addition, in the 3GPP, specifications of a succession system of the LTE called 5G, New Radio (NR) or Next Generation (NG) have been studied.

In the Internet of things (IoT) for industry, it has been discussed to remotely control machines (for example, robot arms) in the production factory via an NR system using Time-Sensitive Networking (TSN) (See Non Patent Document 1).

### PRIOR ART DOCUMENT

### Non-Patent Document

Non Patent Document 1: 3GPP TR 23.734 V16.0.0 3rd Generation Partnership Project; Technical Specification Group Services and System Aspects; Study on enhancement of 5GS for Vertical and LAN Services (Release 16), 3GPP, December 2018

### SUMMARY OF THE INVENTION

Non Patent Document 1 discusses that each of a plurality of TSNs remotely controls an end station of a corresponding TSN via an NR system.

In this case, each TSN needs to notify the end station of the corresponding TSN of a TSN time that is a time reference at which the end station operates, via the NR system.

For this reason, in the NR system, a gNB receives a TSN time from each of the plurality of TSNs via a core network.

However, when receiving a plurality of TSN times, the gNB cannot identify to which user equipment (UE) each TSN time should be transmitted, among a plurality of UEs to which end stations are connected.

For this reason, the gNB cannot notify each TSN time to an appropriate end station.

Therefore, the present invention has been made in view of such a situation, and an object of the present invention is to provide a radio base station and a user equipment that can notify each TSN time to an appropriate end station, when each of a plurality of TSNs remotely controls an end station of a corresponding TSN via an NR system.

A radio base station (200) according to an aspect of the present invention includes a receiving unit (203) that receives a plurality of pieces of time information (T1, T2, and T3); a control unit (205) that associates a time identifier (TSN1, TSN2, and TSN3) with each of the plurality of pieces of time information (T1, T2, and T3); and a transmitting unit (201) that transmits the plurality of pieces of time information (T1, T2, and T3) and the time identifier (TSN1, TSN2, and TSN3) associated with each of the plurality of pieces of time information (T1, T2, and T3) to a user equipment (100a, 100b, and 100c), wherein each piece of time information (T1, T2, and T3) is a time reference in a predetermined network (TSN20a, TSN20b, and TSN20c).

A radio base station (200) according to an aspect of the present invention includes a first communication device (DU230) that communicates with a user equipment (100a, 100b, and 100c); and a second communication device (CU210) that is connected to the first communication device (DU230) and communicates with the user equipment (100a, 100b, and 100c) via the first communication device (DU230), wherein the first communication device (DU230) includes a transmitting unit (101) that broadcasts system information including reference time information that is a time reference in a predetermined network, and the second communication device (CU210) includes a control unit (105) that selects an offset value associated with a predetermined user equipment from a plurality of offset values for the reference time information, and a transmitting unit (101) that transmits an RRC message including the selected offset value to the predetermined user equipment.

A user equipment (100a, 100b, and 100c) according to an aspect of the present invention include a receiving unit (103) that receives a plurality of pieces of time information (T1, T2, and T3), and a time identifier (TSN1, TSN2, and TSN3) associated with each of the plurality of pieces of time information (T1, T2, and T3), from a radio base station (200); and a control unit (105) that selects time information associated with a predetermined time identifier (TSN1, TSN2, and TSN3) held by the user equipment (100a, 100b, and 100c) from the plurality of pieces of time information (T1, T2, and T3), wherein each piece of time information (T1, T2, and T3) is a time reference in a predetermined network (TSN20a, TSN20b, and TSN20c).

A user equipment (100a, 100b, and 100c) according to an aspect of the present invention include a receiving unit (103) that receives reference time information that is a time reference in a first predetermined network, and an offset value for the reference time information, from a radio base station (200); and a control unit (105) that determines time information that is a time reference in a second predetermined network based on the reference time information and the offset value.

### BRIEF DESCRIPTION OF DRAWINGS

FIG. 1 is an overall schematic diagram of a remote control system 10.

FIG. 2 is a functional block configuration diagram of UEs 100a, 100b, and 100c.

FIG. 3 is a functional block configuration diagram of a gNB 200.

FIG. 4 is a diagram illustrating an association between a time identifier and a TSN time.

FIG. 5 is a diagram illustrating an example of an information element including the association between the time identifier and the TSN time.

FIG. 6 is a diagram for explaining each parameter in the information element illustrated in FIG. 5.

FIG. 7 is a diagram illustrating an example of a sequence of first notification processing.

FIG. 8 is a diagram illustrating an example of a sequence of second notification processing.

FIG. 9 is a diagram illustrating an example of a sequence of notification processing according to a modified example.

FIG. 10 is a diagram illustrating an example of a hardware configuration of the UEs 100a, 100b, and 100c, and the gNB 200.

### MODES FOR CARRYING OUT THE INVENTION

Hereinafter, embodiments will be described with reference to the drawings. Note that the same functions or configurations will be denoted by the same or similar reference numerals, and a description thereof will be appropriately omitted.

### (1) Overall Schematic Configuration of Network

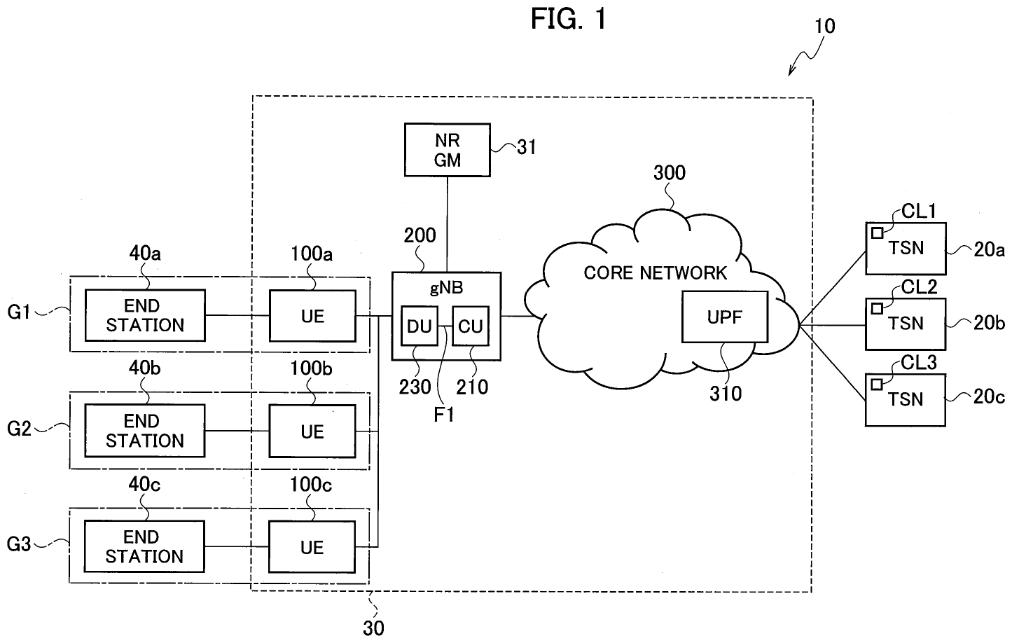

FIG. 1 is an overall schematic diagram of a remote control system 10 according to an embodiment.

The remote control system 10 includes TSNs 20a, 20b, and 20c, an NR system 30, and end stations 40a, 40b, and 40c. In the remote control system 10, the TSNs 20a, 20b, and 20c remotely control end stations 40a, 40b, and 40c of the TSNs 20a, 20b, and 20c in real time via the NR system 30, respectively.

Each of the TSNs 20a, 20b, and 20c oscillates a clock for generating a TSN time with high accuracy. Hereinafter, the clocks oscillated by the TSNs 20a, 20b, and 20c are referred to as TSN clocks CL1, CL2, and CL3. In addition, times generated based on the TSN clocks CL1, CL2, and CL3 are referred to as TSN times T1, T2, and T3 (time information).

The TSN time T1 is a time reference in the TSN 20a, and is a time reference at which the end station 40a operates. The TSN time T2 is a time reference in the TSN 20b, and is a time reference at which the end station 40b operates. The TSN time T3 is a time reference in the TSN 20c, and is a time reference at which the end station 40c operates.

In the remote control system 10, in order to realize remote control in real time, it is necessary to match a time used at a control source (not illustrated) of the TSN 20a and a time used at the end station 40a with the TSN time T1. For the same reason, it is necessary to match a time used at a control source (not illustrated) of the TSN 20b and a time used at the end station 40b with the TSN time T2, and it is necessary to match a time used at a control source (not illustrated) of the TSN 20c and a time used at the end station 40c with the TSN time T3.

Therefore, the TSNs 20a, 20b, and 20c transmit the generated TSN times T1, T2, and T3 to the control sources of the TSNs 20a, 20b, 20c, and also transmit the generated TSN times T1, T2, and T3 to the end stations 40a, 40b, and 40c via the NR system 30.

The NR system 30 includes an NR grand master (NR GM) 31, UEs 100a, 100b, and 100c, a gNB 200, and a core network 300. The NR GM 31 oscillates a clock that is an operation timing of the NR system 30. Hereinafter, the clock oscillated by the NR GM 31 is referred to as an NR grand master clock (NR GMC). In addition, a time generated based on the NR GMC is called an NR time (time information). The NR time is a time reference at which the gNB 200 operates.

The UEs 100a, 100b, and 100c reside in one cell (not illustrated) under control of the gNB 200. Note that a maximum of 300 UEs can reside in one cell under control of the gNB 200.

The UEs 100a, 100b, and 100c belong to TSN groups G1, G2, and G3 in one cell under control of the gNB 200. The TSN groups G1, G2, and G3 correspond to TSNs 20a, 20b, and 20c, respectively. Note that, in one cell under control of the gNB 200, a plurality of UEs is grouped into a maximum of 32 TSN groups.

The UEs 100a, 100b, and 100c perform radio communication according to the NR between the UEs 100a, 100b, and 100c and the gNB 200, and between the UEs 100a, 100b, and 100c and the core network 300. The UEs 100a, 100b, and 100c periodically receive system information broadcasted from the gNB 200. The UEs 100a, 100b, and 100c individually receive an RRC message transmitted from the gNB 200.

The UEs 100a, 100b, and 100c are notified in advance of time identifiers TSN1, TSN2, and TSN3 from the core network 300 through, for example, a downlinkNAStransport message from a NAS layer (higher layer). Note that the UEs 100a, 100b, and 100c may be notified in advance of the time identifiers TSN1, TSN2, and TSN3 from the control sources of the TSNs 20a, 20b, and 20c or an application layer. The time identifiers TSN1, TSN2, and TSN3 are used to identify the TSN times T1, T2, and T3 that are the time references for operation of the end stations 40a, 40b, and 40c connected to the UEs 100a, 100b, and 100c.

The gNB 200 performs radio communication according to the NR between the gNB 200 and the core network 300. The time identifiers TSN1, TSN2, and TSN3 are notified in advance to the gNB 200 from the core network 300. Note that the time identifiers TSN1, TSN2, and TSN3 may be notified in advance to the gNB 200 from the control sources of the TSNs 20a, 20b, and 20c or an operator. The gNB 200 receives the TSN times T1, T2, and T3 from the core network 300.

For example, the gNB 200 associates the time identifiers TSN1, TSN2, and TSN3 with the received TSN times T1, T2, and T3, respectively, according to a rule given in advance by the operator or the like. The gNB 200 broadcasts system information including the TSN times T1, T2, and T3 and the time identifiers TSN1, TSN2, and TSN3 associated with the TSN times T1, T2, and T3 at a predetermined transmission timing based on the NR GMC.

The gNB 200 may transmit, to a predetermined UE, an RRC message including the TSN times T1, T2, and T3 and the time identifiers TSN1, TSN2, and TSN3 associated with the TSN times T1, T2, and T3, instead of the system information.

When receiving the above-described system information or RRC message from the gNB 200, each of the UEs 100a, 100b, and 100c selects a TSN time associated with a time identifier notified in advance, among a plurality of TSN times.

Each of the UEs 100a, 100b, and 100c transmits the selected TSN time to the corresponding end station.

Further, the gNB 200 broadcasts system information (for example, SIBS) including a predetermined TSN time or NR time. The gNB 200 selects an offset value associated with a predetermined UE, among a plurality of offset values for the predetermined TSN time or NR time. The gNB 200 transmits an RRC message (e.g., RRC dedicated signaling) including the selected offset value to the predetermined UE.

When receiving each of the system information and the RRC message described above from the gNB 200, each of the UEs 100a, 100b, and 100c determines a TSN time that is a time reference for operation of the corresponding end station by adding the offset value included in the RRC message to the predetermined TSN time or NR time included in the system information.

Each of the UEs 100a, 100b, and 100c transmits the determined TSN time to the corresponding end station.

The offset value described above is a fixed value for difference between a TSN clock that generates the predetermined TSN time or an NR clock that generates the NR time, and a TSN clock that generates the TSN time that is the time reference for operation of the end station connected to the predetermined UE.

The gNB 200 may further include an offset value between the predetermined TSN time and each TSN time, or an identifier associated with the offset value, with respect to the system information including the predetermined TSN time or NR time.

In this case, when receiving the above-described system information from the gNB 200, each of the UEs 100a, 100b, and 100c selects an offset value notified in advance from a network (for example, a NAS layer) or an identifier associated with the offset value, among a plurality of offset values included in the system information or a plurality of identifiers associated with the plurality of offset values.

When selecting the offset value, each of the UEs 100a, 100b, and 100c determines a TSN time that is a time reference for operation of the corresponding end station, by adding the selected offset value to the predetermined TSN time or NR time included in the system information described above.

When selecting the identifier associated with the offset value, each of UEs 100a, 100b, and 100c determines a TSN time that is a time reference for operation of the corresponding end station, by adding an offset value corresponding to the selected identifier of the offset value to the predetermined TSN time or NR time included in the system information described above.

Note that the gNB 200 may broadcast system information different from the system information including the predetermined TSN time or NR time, including an offset value between the predetermined TSN time and each TSN time, or an identifier associated with the offset value.

The gNB 200 includes a central unit (CU) 210 and a distributed unit (DU) 230. The CU 210 is arranged on the core network 300 side and controls the DU 230. The CU 210 may control a plurality of DUs 230.

The CU 210 is connected to the DU 230 via an F1 interface (for example, an optical fiber). The CU 210 communicates with the UE 100a, 100b, and 100c via the DU 230. The CU 210 can encode the system information and the RRC message.

Therefore, the CU 210 can transmit the system information or the RRC message including the TSN times T1, T2, and T3 and the time identifiers TSN1, TSN2, and TSN3 associated with the TSN times T1, T2, and T3, described above. Further, the CU 210 transmits the RRC message including the offset value described above.

The DU 230 is arranged on the UEs 100a, 100b, and 100c side, and communicates with UEs 100a, 100b, and 100c. The DU 230 can encode the system information.

Accordingly, the DU 230 can transmit the system information including the TSN times T1, T2, and T3, and the time identifiers TSN1, TSN2, and TSN3 associated with the TSN times T1, T2, T3, described above. Further, the DU 230 transmits the system information including the predetermined TSN time or NR time described above.

The core network 300 communicates with the UEs 100a, 100b, and 100c via the gNB 200. The core network 300 includes a user plane function (UPF) 310. The UPF 310 provides functions specialized for U-plane processing. The UPF 310 receives the TSN times T1, T2, and T3 from the TSNs 20a, 20b, and 20c. The UPF 310 transmits the received TSN times T1, T2, and T3 to the gNB 200.

Each of the end stations 40a, 40b, and 40c is a machine (for example, a robot arm) provided in the production factory. The end station 40a receives the TSN time T1 from the UE 100a. The end station 40a occasionally updates the TSN time T1 held by the end station 40a based on the received TSN time T1.

Similarly, the end stations 40b and 40c receive the TSN times T2 and T3 from the UEs 100b and 100c, respectively. The end stations 40b and 40c occasionally update the TSN times T2 and T3 held by the end stations 40b and 40c based on the received TSN times T2 and T3, respectively.

Each of the end stations 40a, 40b, and 40c receives a command from the control source of the corresponding TSN via the NR system 30. For example, when receiving a command from the control source of the TSN 20a, the end station 40a determines whether or not the TSN time T1 held by the end station 40a reaches a predetermined TSN time based on the predetermined TSN time included in the received command and the TSN time T1 held by the end station 40a.

When the end station 40a determines that the predetermined TSN time is reached, the end station 40a performs an operation based on the received command. As described above, the control sources of TSN1, TSN2, and TSN3 perform real-time remote control by performing time scheduling for operating the end stations 40a, 40b, and 40c based on the TSN times T1, T2, and T3, respectively.

### (2) Functional Block Configuration of UE 100a, 100b, and 100c

Next, a functional block configuration of the UEs 100a, 100b, and 100c will be described. Hereinafter, only portions related to the features in the present embodiment will be described. Therefore, the UEs 100a, 100b, and 100c include other functional blocks that are not directly related to the features in the present embodiment.

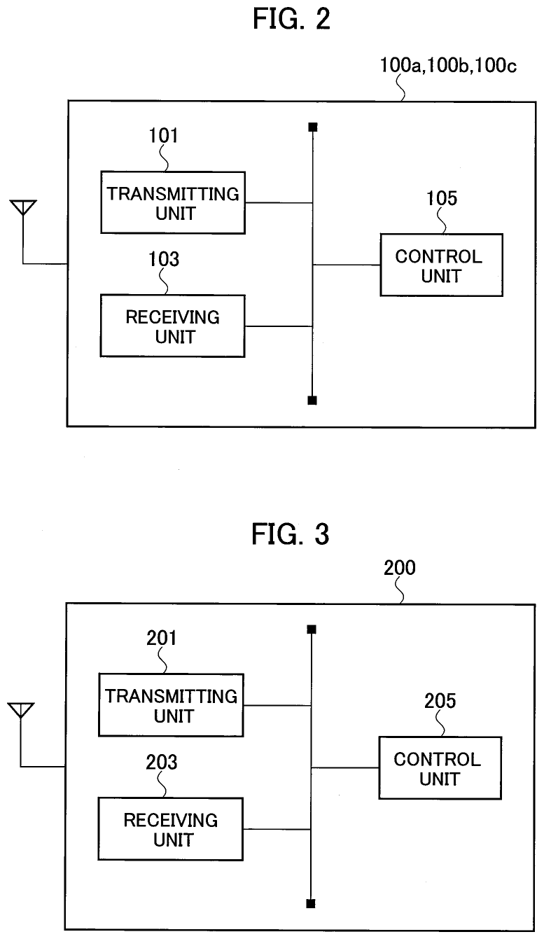

FIG. 2 is a functional block configuration diagram of the UEs 100a, 100b, and 100c. Note that a hardware configuration of the UEs 100a, 100b, and 100c will be described later. Since the UEs 100a, 100b, and 110c have the same configuration, the configuration of UE 100a will be described as an example in the following description.

As illustrated in FIG. 2, the UE 100a includes a transmitting unit 101, a receiving unit 103, and a control unit 105.

The transmitting unit 101 transmits an uplink signal according to the NR to the gNB 200. The transmitting unit 101 transmits the command from the control source of the TSN 20a and the TSN time T1 to the end station 40a.

The receiving unit 103 receives a downlink signal according to the NR from the gNB 200. For example, the receiving unit 103 receives the time identifier TSN1 from the core network 300 through a NAS layer. The receiving unit 103 receives the command from the control source of the TSN 20a, the system information, and the RRC message from the gNB 200. The receiving unit 103 receives a response signal and the like from the end station 40a.

When the receiving unit 103 receives the system information or the RRC message including the TSN times T1, T2, and T3 and the time identifiers TSN1, TSN2, and TSN3 associated with the TSN times T1, T2, and T3, the control unit 105 selects the TSN time T1 associated with the time identifier TSN1 notified in advance, among the TSN times T1, T2, and T3.

The control unit 105 instructs the transmitting unit 101 to transmit the selected TSN time T1 to the end station 40a. When receiving the command from the control source of the TSN 20a, the control unit 105 instructs the transmitting unit 101 to transmit the received command to the end station 40a.

Further, when the receiving unit 103 receives the system information including a predetermined TSN time or NR time and the RRC message including an offset value, the control unit 105 determines the TSN time T1 that is the time reference for operation of the end station 40a by adding the offset value to the predetermined TSN time or NR time.

The control unit 105 instructs the transmitting unit 101 to transmit the determined TSN time T1 to the end station 40a.

### (3) Functional Block Configuration of gNB 200

Next, a functional block configuration of the gNB 200 will be described. Hereinafter, only portions related to the features in the present embodiment will be described. Therefore, the gNB 200 includes other functional blocks that are not directly related to the features in the present embodiment.

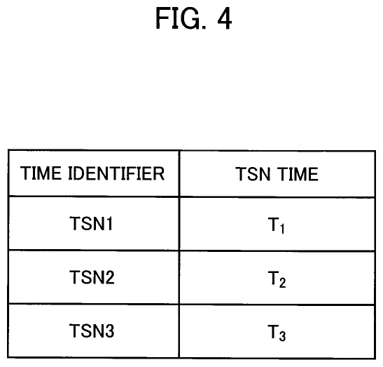

FIG. 3 is a functional block configuration diagram of a gNB 200. A hardware configuration of the gNB 200 will be described later. As illustrated in FIG. 3, the gNB 200 includes a transmitting unit 201, a receiving unit 203, and a control unit 205.

The transmitting unit 201 transmits the commands from the control sources of the TSNs 20a, 20b, and 20c, the system information, and the RRC message to the UEs 100a, 100b, and 100c.

The receiving unit 203 receives the commands from the control sources of the TSNs 20a, 20b, and 20c, the TSN times T1, T2, and T3 and the time identifiers TSN1, TSN2, and TSN3 from the core network 300.

When the receiving unit 203 receives the TSN times T1, T2, and T3, the control unit 205 associates the time identifiers TSN1, TSN2, and TSN3 notified in advance with the received TSN times T1, T2, and T3, respectively, according to a rule given in advance by an operator or the like. When the gNB 200 includes the TSN times T1, T2, and T3 and the time identifiers TSN1, TSN2, and TSN3 associated with the TSN times T1, T2, and T3 in the system information, the gNB 200 instructs the transmitting unit 201 to broadcast the system information at the transmission timing based on the NR GMC.

When the control unit 205 includes the TSN times T1, T2, and T3 and the time identifiers TSN1, TSN2, and TSN3 associated with the TSN times T1, T2, and T3 in the RRC message, the control unit 205 instructs the transmitting unit 201 to transmit the RRC message to a predetermined UE.

In addition, the control unit 205 instructs the transmitting unit 201 to broadcast the system information including a predetermined TSN time or NR time at the transmission timing based on the NR GMC. The control unit 205 selects an offset value associated with a predetermined UE among a plurality of offset values for the predetermined TSN time or NR time. The control unit 205 instructs the transmitting unit 201 to transmit the RRC message including the selected offset value to the predetermined UE.

### (4) Operation of NR System

Next, an operation of the NR system 30 will be described.

### (4.1) Association Between TNS Time and Time Identifier

FIG. 4 is a diagram illustrating an association between the time identifier and the TSN time. When receiving the TSN times T1, T2, and T3 from the core network 300, the gNB 200 associates the time identifiers TSN1, TSN2, and TSN3 notified in advance with the TSN times T1, T2, and T3 according to a rule given in advance by an operator or the like, as illustrated in FIG. 4.

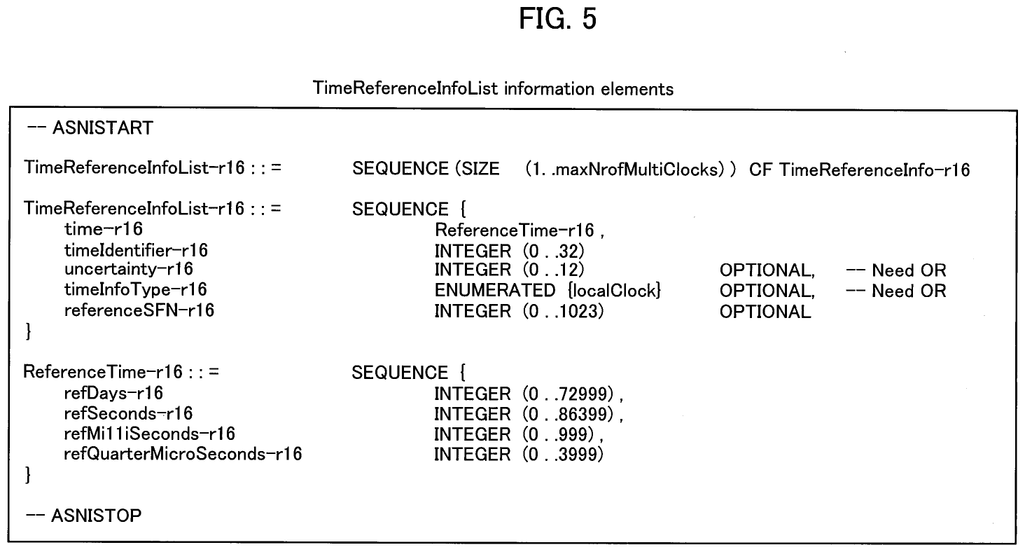

FIG. 5 is a diagram illustrating an example of an information element including the association between the time identifier and the TSN time. As illustrated in FIG. 5, the association between the time identifier and the TSN time is included in a TimeReferenceInfoList-r16 information element. The TimeReferenceInfoList-r16 information element is set in the system information (for example, SIBS) or the RRC message (for example, DLInformationTransfer message).

The TimeReferenceInfoList-r16 has five parameters (time-r16, timeIdentifier-r16, uncertainty-r16, timeInfoType-r16, and referenceSFN-r16).

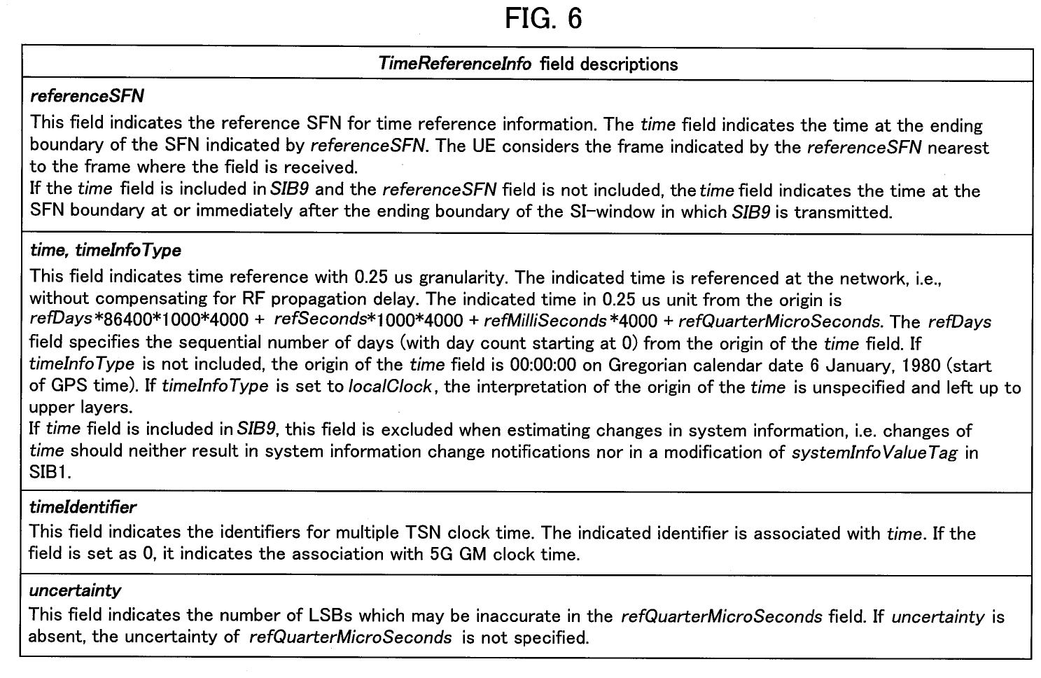

FIG. 6 is a diagram for explaining each parameter in the information element illustrated in FIG. 5. As illustrated in FIG. 6, a time is specified in the time-r16 (time information). In the time-r16, a time increment accuracy is 0.25 μm.

In the timeIdentifier-r16 (time identifier), one of the numerical values 0 to 32 is specified. The timeIdentifier-r16 is associated with the time-r16. In the timeIdentifier, when the value 0 is specified, the time specified by the time-r16 is identified as the NR time generated based on the NR GMC.

On the other hand, when one of the numerical values 1 to 32 is specified in the timeIdentifier, the time specified by the time-r16 is identified as the TSN time generated based on the TSN clock corresponding to the specified number.

An uncertainty-r16 specifies the tolerance of error at the time specified by the time-r16. Specifically, if the error at the time specified by the time-r16 is within 0.25 μs+α, the error is allowed.

In the timeInfoType-r16, it is specified whether or not the time specified by the time-r16 is set based on a local clock (for example, TSN clock).

In the referenceSFN-r16, a subframe number for reading the time specified by the time-r16 is specified.

### (4.2) First Notification Processing

In first notification processing, the gNB 200 broadcasts the system information including the TSN times T1, T2, and T3 and the time identifiers TSN1, TSN2, and TSN3 associated with the TSN times T1, T2, and T3.

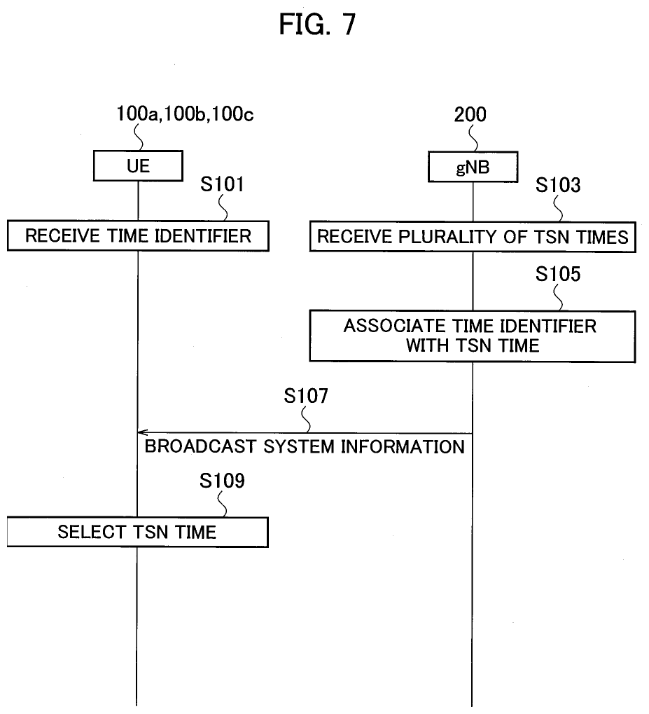

FIG. 7 is a diagram illustrating an example of a sequence of the first notification processing.

The time identifiers TSN1, TSN2, and TSN3 are notified in advance to the UEs 100a, 100b, and 100c, from the core network 300 through a NAS layer (S101). The gNB 200 receives the TSN times T1, T2, and T3 from the core network 300 (S103).

When receiving the TSN times T1, T2, and T3, the gNB 200 associates the time identifiers TSN1, TSN2, and TSN3 notified in advance with the received TSN times T1, T2, and T3, respectively, according to a rule given in advance by an operator or the like (S105).

The gNB200 includes the TSN times T1, T2, and T3 and the time identifiers TSN1, TSN2, and TSN3 associated with the TSN times T1, T2, and T3 in the system information, and broadcasts the system information at a transmission timing based on the NR GMC (S107).

When receiving the system information, the UE 100a selects the TSN time T1 associated with the time identifier TSN1 notified in advance among the TSN times T1, T2, and T3 included in the system information (S109). The UE 100a transmits the selected TSN time T1 to the end station 40a.

When receiving the system information, the UE 100b selects the TSN time T2 associated with the time identifier TSN2 notified in advance among the TSN times T1, T2, and T3 included in the system information (S109). The UE 100b transmits the selected TSN time T2 to the end station 40b.

When receiving the system information, the UE 100c selects the TSN time T3 associated with the time identifier TSN3 notified in advance among the TSN times T1, T2, and T3 included in the system information (S109). The UE 100c transmits the selected TSN time T3 to the end station 40c.

Note that the UE 100a, 100b, and 100c may calculate the tolerance of the error when the tolerance of the error at the TSN times T1, T2, and T3 is specified in the system information.

### (4.3) Second Notification Processing

In second notification processing, the gNB 200 transmits the RRC message including the TSN times T1, T2, and T3 and the time identifiers TSN1, TSN2, and TSN3 associated with TSN times T1, T2, and T3.

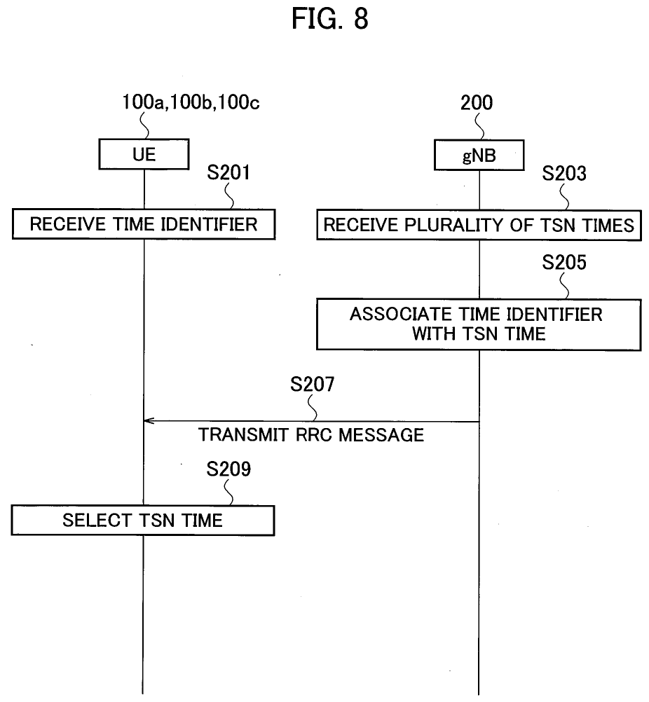

FIG. 8 is a diagram illustrating an example of a sequence of the second notification processing.

The time identifiers TSN1, TSN2, and TSN3 are notified in advance to the UEs 100a, 100b, and 100c, from the core network 300 through a NAS layer (S201). The gNB 200 receives the TSN times T1, T2, and T3 from the core network 300 (S203).

When receiving the TSN times T1, T2, and T3, the gNB 200 associates the time identifiers TSN1, TSN2, and TSN3 notified in advance with the received TSN times T1, T2, and T3, respectively, according to a rule given in advance by an operator or the like (S205).

The gNB 200 includes the TSN times T1, T2, and T3 and the time identifiers TSN1, TSN2, and TSN3 associated with the TSN times T1, T2, and T3 in the RRC message, and transmits the RRC message to the UEs 100a, 100b, and 100c (S207).

When receiving the RRC message, the UE 100a selects the TSN time T1 associated with the time identifier TSN1 notified in advance among the TSN times T1, T2, and T3 included in the RRC message (S209). The UE 100a transmits the selected TSN time T1 to the end station 40a.

When receiving the RRC message, the UE 100b selects the TSN time T2 associated with the time identifier TSN2 notified in advance among the TSN times T1, T2, and T3 included in the RRC message (S209). The UE 100b transmits the selected TSN time T2 to the end station 40b.

When receiving the RRC message, the UE 100c selects the TSN time T3 associated with the time identifier TSN3 notified in advance among the TSN times T1, T2, and T3 included in the RRC message (S209). The UE 100c transmits the selected TSN time T3 to the end station 40c.

Note that the UE 100a, 100b, 100c may calculate the tolerance of the error when the tolerance of the error at the TSN times T1, T2, and T3 is specified in the RRC message.

### (4.4) Modified Example

Instead of the first and second notification processing described above, the gNB 200 may broadcast the system information including a predetermined TSN time or NR time, and may also transmit the RRC message including an offset value with respect to the predetermined TSN time or NR time to a predetermined UE, as described below.

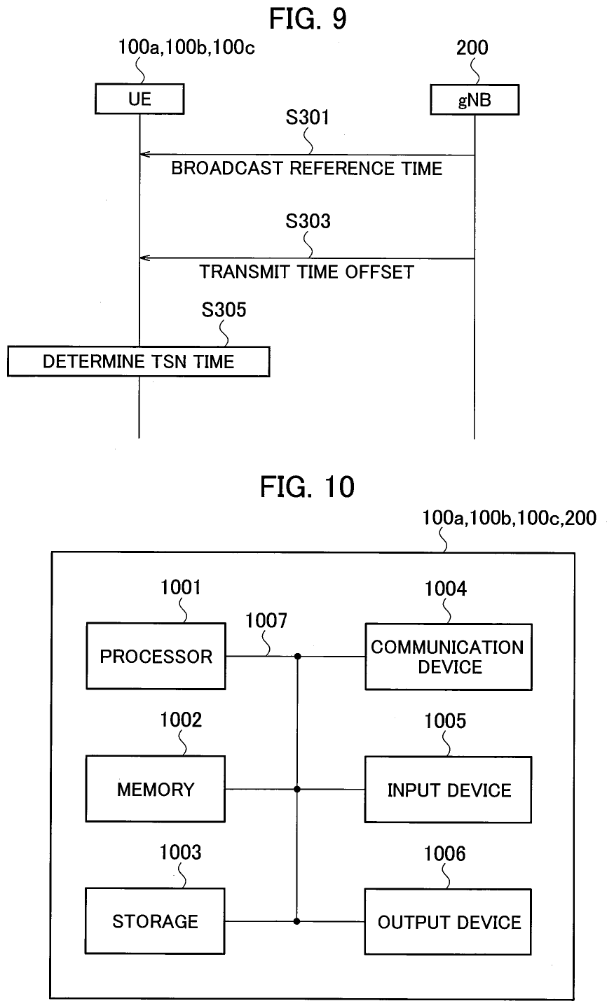

FIG. 9 is a diagram illustrating an example of a sequence of notification processing according to a modified example.

The DU 230 of the gNB 200 broadcasts the system information including a predetermined TSN time or NR time (S301). The gNB 200 selects an offset value associated with a predetermined UE among a plurality of offset values for the predetermined TSN time or NR time. The CU 210 of the gNB 200 transmits the RRC message including the selected offset value to the predetermined UE (S303).

When receiving the system information and the RRC message, the UE 100a determines the TSN time T1 that is the time reference for operation of the corresponding end station 40a, by adding the offset value included in the RRC message to the TSN time or NR time included in the system information (S305). The UE 100a transmits the determined TSN time T1 to the end station 40a.

When receiving the system information and the RRC message, the UE 100b determines the TSN time T2 that is the time reference for operation of the corresponding end station 40b, by adding the offset value included in the RRC message to the TSN time or NR time included in the system information (S305). The UE 100b transmits the determined TSN time T2 to the end station 40b.

When receiving the system information and the RRC message, the UE 100c determines the TSN time T3 that is the time reference for operation of the corresponding end station 40c, by adding the offset value included in the RRC message to the TSN time or NR time included in the system information (S305). The UE 100c transmits the determined TSN time T3 to the end station 40c.

### (5) Action and Effect

According to the embodiment described above, the gNB 200 includes the receiving unit 203 that receives the TSN times T1, T2, and T3, the control unit 205 that associates the time identifiers TSN1, TSN2, and TSN3 with the TSN times T1, T2, and T3, and the transmitting unit 201 that transmits the TSN times T1, T2, and T3 and the time identifiers TSN1, TSN2, and TSN3 associated with the TSN times T1, T2, and T3 to the UEs 100a, 100b, and 100c. The TSN times T1, T2, and T3 are time references in the TSNs 20a, 20b, and 20c, respectively.

With such a configuration, each UE can select the TSN time associated with the time identifier held by the UE, among the TSN times T1, T2, and T3 transmitted from the gNB 200. Each UE transmits the selected TSN time to an end station connected to the UE.

Therefore, the gNB 200 can notify each TSN time to an appropriate end station.

According to the present embodiment, the transmitting unit 201 of the gNB 200 broadcasts the system information including the TSN times T1, T2, and T3 and the time identifiers TSN1, TSN2, and TSN3 associated with the TSN times T1, T2, and T3.

With such a configuration, even if it is not possible to identify to which UE each TSN time should be transmitted, among the UEs 100a, 100b, and 100c to which the end stations 40a, 40b, and 40c are connected, the gNB 200 can notify each TSN time to the appropriate end station.

Further, in the conventional NR system, the system information (for example, SIBS) for broadcasting the time broadcasts only one time, but with such a configuration, the system information can broadcast a plurality of times.

According to the present embodiment, the transmitting unit 201 of the gNB 200 transmits the RRC message including the TSN times T1, T2, and T3 and the time identifiers TSN1, TSN2, and TSN3 associated with the TSN times T1, T2, and T3.

With such a configuration, even if it is not possible to identify to which UE each TSN time should be transmitted, among the UEs 100a, 100b, and 100c to which the end stations 40a, 40b, and 40c are connected, the gNB 200 can notify each TSN time to the appropriate end station.

According to the present embodiment, the control unit 205 of the gNB 200 associates a predetermined time identifier with an NR time that is a time reference in the NR system 30 in which the gNB 200 operates.

With such a configuration, the gNB 200 can include the association between the NR time and the time identifier in the message, in addition to the association between the TSN times T1, T2, and T3 and the time identifiers TSN1, TSN2, and TSN3.

According to the present embodiment, the gNB 200 includes the DU 230 that communicates with the UEs 100a, 100b, and 100c, and the CU 210 that is connected to the DU 230 and communicates with the UEs 100a, 100b, and 100c via the DU 230. The DU 230 broadcasts the system information including one reference time among the TSN times T1, T2, and T3, and the NR time, that are time references in the TSNs 20a, 20b, and 20c and the NR system 300.

The CU 210 selects an offset value associated with each of the UE 100a, 100b, and 100c from a plurality of offset values with respect to the reference time. The CU 210 transmits an RRC message including the selected offset value to each of the UEs 100a, 100b, and 100c.

With such a configuration, each UE can determine a TSN time that is a time reference at which an end station connected to the UE operates, based on the reference time and the offset value transmitted from the gNB 200. Each UE transmits the determined TSN time to the end station connected to the UE.

Therefore, the gNB 200 can notify each TSN time to an appropriate end station.

Further, since the reference time is transmitted by the DU 230, it is not necessary to correct a time delay between the CU 210 and the DU 230. The offset value is transmitted by the CU 210, but since the offset value is a fixed value, it is not necessary to correct the time delay between the CU 210 and the DU 230.

For this reason, the gNB 200 can notify an appropriate end station of a highly accurate TSN time.

According to the present embodiment, each of the UEs 100a, 100b, and 100c includes the receiving unit 103 that receives the TSN times T1, T2, and T3 and the time identifiers TSN1, TSN2, and TSN3 associated with the TSN times T1, T2, and T3 from the gNB 200, and the control unit 105 that selects a TSN time associated with a predetermined time identifier held by each of the UEs 100a, 100b, and 100c, from the TSN times T1, T2, and T3. The TSN times T1, T2, and T3 are time references in the TSNs 20a, 20b, and 20c, respectively.

With such a configuration, each UE can select the TSN time associated with the predetermined time identifier held by the UE, from TSN times T1, T2, and T3. Each UE transmits the selected TSN time to an end station connected to the UE.

Therefore, the UE 100a, 100b, and 100c can notify each TSN time to an appropriate end station.

According to the present embodiment, each of the UEs 100a, 100b, and 100c receives, from the gNB 200, one reference time from the TSN times T1, T2, and T3, and the NR time that are the time references in the TSN 20a, 20b, and 20c and the NR system 300, and the offset value associated with the reference time. Each of the UEs 100a, 100b, and 100c determines a TSN time that is a time reference at which the end station connected to the UE operates, based on the reference time and the offset value.

With such a configuration, each UE can determine the TSN time that is the time reference at which the end station connected to the UE operates. Each UE transmits the determined TSN time to the end station connected to the UE.

Therefore, the UE 100a, 100b, and 100c can notify each TSN time to an appropriate end station.

### (6) Other Embodiments

Hereinabove, although the contents of the present invention have been described according to the embodiments, the present invention is not limited to these descriptions, and it will be apparent to those skilled in the art that various modifications and improvements can be made.

The block diagram used for explaining the embodiments (FIGS. 2 and 3) illustrates blocks of functional unit. Those functional blocks (structural components) are realized by a desired combination of at least one of hardware and software. A method for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (structural component) that causes transmitting is called a transmitting unit or a transmitter. For any of the above, as explained above, the realization method is not particularly limited to any one method.

Furthermore, the UEs 100a, 100b, and 100c and the gNB 200 explained above may function as a computer that performs the processing of the radio communication method of the present disclosure. FIG. 9 is a diagram illustrating an example of a hardware configuration of the device. As illustrated in FIG. 9, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. A hardware configuration of the device may be constituted by including one or plurality of the devices illustrated in the figure, or may be constituted by without including a part of the devices.

The functional blocks of the device are realized by any of hardware elements of the computer device or a desired combination of the hardware elements.

Moreover, the processor 1001 performs operation by loading a predetermined software (program) on hardware such as the processor 1001 and the memory 1002, and realizes various functions of the device by controlling communication via the communication device 1004 and controlling at least one of reading and writing of data on the memory 1002 and the storage 1003.

The processor 1001, for example, operates an operating system to control the entire computer. The processor 1001 may be configured with a central processing unit (CPU) including an interface with a peripheral device, a control device, a computing device, a register, and the like.

Moreover, the processor 1001 reads a program (program code), a software module, data, and the like from at least one of the storage 1003 and the communication device 1004 into the memory 1002, and executes various processing according to them. As the program, a program that is capable of executing on the computer at least a part of the operation explained in the above embodiments, is used. Alternatively, various processing explained above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of read only memory (ROM), erasable programmable ROM (EPROM), electrically erasable programmable ROM (EEPROM), random access memory (RAM), and the like. The memory 1002 may be called register, cache, main memory (main storage device), and the like. The memory 1002 can store therein a program (program codes), software modules, and the like that can execute the method according to the embodiment of the present disclosure.

The storage 1003 is a computer readable recording medium. Examples of the storage 1003 include at least one of an optical disk such as compact disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 may be called an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of frequency division duplex (FDD) and time division duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information therebetween. The bus 1007 may be constituted by a single bus or may be constituted by separate buses between the devices.

Further, the device may be configured to include hardware such as a microprocessor, a digital signal processor (DSP), an application specific integrated circuit (ASIC), a programmable logic device (PLD), and a field programmable gate array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, downlink control information (DCI), uplink control information (UCI), higher layer signaling (for example, RRC signaling, medium access control (MAC) signaling, broadcast information (master information block (MIB), system information block (SIB)), other signals, or a combination of these. The RRC signaling may be called RRC message, for example, or may be RRC Connection Setup message, RRC Connection Reconfiguration message, or the like.

Each of the above aspects/embodiments may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-Wideband (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from a higher layer (or lower layer) to a lower layer (or higher layer). It may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by a value (0 or 1) represented by one bit or by a Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, optical fiber cable, twisted pair, digital subscriber line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in the present disclosure and terms necessary for understanding the present disclosure may be replaced by terms having the same or similar meanings. For example, at least one of a channel and a symbol may be a signal (signaling). Also, a signal may be a message. Further, a component carrier (CC) may be referred to as a carrier frequency, a cell, a frequency carrier, or the like.

The terms “system” and “network” used in the present disclosure can be used interchangeably.

Furthermore, the information, the parameter, and the like explained in the present disclosure may be represented by an absolute value, may be expressed as a relative value from a predetermined value, or may be represented by corresponding other information. For example, the radio resource may be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (base station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (remote radio head: RRH)).

The term “cell” or “sector” refers to a part or all of the coverage area of at least one of a base station and a base station subsystem that perform communication service in this coverage.

In the present disclosure, the terms “mobile station (mobile station: MS)”, “user terminal”, “user equipment (user equipment: UE)”, “terminal” and the like can be used interchangeably.

The mobile station may be called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), or a robot (manned type or unmanned type). At least one of a base station and a mobile station can be a device that does not necessarily move during the communication operation. For example, at least one of a base station and a mobile station may be an Internet of things (IoT) device such as a sensor.

Also, a base station in the present disclosure may be read as a mobile station (user terminal, hereinafter the same applies). For example, each of the aspects/embodiments of the present disclosure may be applied to a configuration that allows a communication between a base station and a mobile station to be replaced with a communication between a plurality of mobile stations (for example, may be referred to as device-to-device (D2D), vehicle-to-everything (V2X), or the like). In this case, the mobile station may have the function of the base station. Words such as “uplink” and “downlink” may also be replaced with wording corresponding to inter-terminal communication (for example, “side”). For example, terms such as an uplink channel, a downlink channel, or the like may be read as a side channel.

Likewise, a mobile station in the present disclosure may be read as a base station. In this case, the base station may have the function of the mobile station.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using at least one of one or more wires, cables, and printed electrical connections, and as some non-limiting and non-exhaustive examples, by using electromagnetic energy having wavelengths in the radio frequency region, the microwave region and light (both visible and invisible) regions, and the like.

The reference signal may be abbreviated as RS and may be called pilot according to applicable standards.

As used in the present disclosure, the phrase “based on” does not mean “based only on” unless explicitly stated otherwise. In other words, the phrase “based on” means both “based only on” and “based at least on”.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles may include plurality of nouns following these articles.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### INDUSTRIAL APPLICABILITY

According to the radio base station and the user equipment described above, when each of the plurality of TSNs remotely controls the end station of the corresponding TSN via the NR system, the TSN time can be notified to the appropriate end station.

### EXPLANATION OF REFERENCE NUMERALS

10 Remote control system
20a, 20b, 20c TSN
30 NR system
31 NR GM
40a, 40b, 40c End station
100a, 100b, 100c UE
101 Transmitting unit
103 Receiving unit
105 Control unit
200 gNB
201 Transmitting unit
203 Receiving unit
205 Control unit
300 Core network
310 UPF
1001 Processor
1002 Memory
1003 Storage
1004 Communication device
1005 Input device
1006 Output device
1007 Bus
CL1, CL2, CL3 TSN clock
T1, T2, T3 TSN time
TSN1, TSN2, TSN3 Time identifier

1. A radio base station comprising:
a receiving unit that receives a plurality of pieces of time information;
a control unit that associates a time identifier with each of the plurality of pieces of time information; and
a transmitting unit that transmits the plurality of pieces of time information and the time identifier associated with each of the plurality of pieces of time information to a user equipment, wherein
each piece of time information is a time reference in a predetermined network.

2. The radio base station according to claim 1, wherein the transmitting unit broadcasts system information including the plurality of pieces of time information and the time identifier associated with each of the plurality of pieces of time information.

3. The radio base station according to claim 1, wherein the transmitting unit transmits an RRC message including the plurality of pieces of time information and the time identifier associated with each of the plurality of pieces of time information.

4. The radio base station according to claim 1, wherein the control unit associates a predetermined time identifier with time information that is a time reference in a network in which the radio base station operates.

5. A radio base station comprising:
a first communication device that communicates with a user equipment; and
a second communication device that is connected to the first communication device and communicates with the user equipment via the first communication device; wherein
the first communication device includes a transmitting unit that broadcasts system information including reference time information that is a time reference in a predetermined network, and
the second communication device includes
a control unit that selects an offset value associated with a predetermined user equipment from a plurality of offset values for the reference time information, and
a transmitting unit that transmits an RRC message including the selected offset value to the predetermined user equipment.

6. A user equipment comprising:
a receiving unit that receives a plurality of pieces of time information and a time identifier associated with each of the plurality of pieces of time information from a radio base station; and
a control unit that selects time information associated with a predetermined time identifier held by the user equipment, from the plurality of pieces of time information, wherein
each piece of time information is a time reference in a predetermined network.

7. A user equipment comprising:
a receiving unit that receives reference time information that is a time reference in a first predetermined network, and an offset value for the reference time information, from a radio base station; and
a control unit that determines time information that is a time reference in a second predetermined network based on the reference time information and the offset value.
